(19) United States
(12) Patent Application Publication
(10) Pub. No.: US 2007/0215471 A1
(43) Pub. Date: Sep. 20, 2007

(54) Exhaust gas sensor

(75) Inventors: Shoichi Sakai, Gunma (JP); Akira Uchikawa, Gunma (JP); Masao Tsukada, Gunma (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/723,006

(22) Filed: Mar. 15, 2007

(30) Foreign Application Priority Data
Mar. 17, 2006 (JP) 2006-074651
Jan. 18, 2007 (JP) 2007-009032

(51) Int. Cl. G01N 27/26

(52) U.S. Cl. 204/424

(57) ABSTRACT

An exhaust gas sensor has a sensing element having a sensing area that detects certain components in exhaust gas, a holder that supports a base end portion of the sensing element and has a sensor-mounting structure for sensor installation, and a protector that is fixed to the holder and protects the sensing area of the sensing element. To support the sensing element, a sensing element insertion hole for receiving the base end portion of the sensing element is formed at the holder. Then, a clearance between an inner surface of the sensing element insertion hole and a surface of the sensing area is set to be smaller than a clearance between an inner surface of the protector and the surface of the sensing area.

### BACKGROUND OF THE INVENTION

The present invention relates to an exhaust gas sensor provided for an exhaust pipe of an internal combustion engine in a vehicle and detecting certain components in exhaust gas.

The exhaust pipe of the internal combustion engine in the vehicle is equipped with the exhaust gas sensor. The exhaust gas sensor detects the certain components in the exhaust gas, and on the basis of the detected components or detected result, an exhaust-emission reduction control is carried out. The exhaust gas sensors have been proposed and developed variously. And one such exhaust gas sensor has been disclosed in Japanese Patent Provisional Publication No. 9-222416 (hereinafter is referred to as “JP9-222416”). In JP9-222416, an oxygen sensor, which is frequently used, is disclosed as the exhaust gas sensor. In addition to the oxygen sensor, a NOx sensor and a linear air-fuel ratio sensor etc. are generally used as the exhaust gas sensor.

### SUMMARY OF THE INVENTION

The above exhaust gas sensors have a sensing or detecting element inside, to detect the certain components. In the exhaust pipe, the exhaust gas flows, and water vapor resides in the exhaust gas. This water vapor condenses and changes to condensed water. The condensed water is scattered by the exhaust gas flow and reaches the sensing element. Then, when the condensed water remains at the sensing element, there is a possibility that not only sensing characteristics will change but also the sensing element will crack. For this reason, in this type of the sensors, a cover called “protector” is attached around the sensing element, and prevents the condensed water from reaching the sensing element. With respect to the protector, it also serves to prevent foreign particles from attaching to or coming into contact with the sensing element.

In JP9-222416 as well, the oxygen sensor can suppress the entry of the condensed water from an outside of the oxygen sensor into the oxygen sensor. However, the condensed water is generated not only outside the oxygen sensor but inside the oxygen sensor (inside the protector) by the condensation of the water vapor. Because of this, even though the oxygen sensor in JP9-222416 can suppress the entry of the condensed water from the outside of the oxygen sensor, the crack of the sensing element might occur by the condensed water generated inside the oxygen sensor.

It is therefore an object of the present invention to provide an exhaust gas sensor which is effectively capable of suppressing the crack of the element, caused by the condensed water generated inside the sensor.

According to one aspect of the present invention, an exhaust gas sensor comprises: a sensing element having a sensing area detecting certain components in exhaust gas; a holder supporting a base end portion of the sensing element and having a sensor-mounting structure for sensor installation; and a protector fixed to the holder and protecting the sensing area of the sensing element, and a clearance between an inner surface of a sensing element insertion hole that is formed at the holder and a surface of the sensing area is set to be smaller than a clearance between an inner surface of the protector and the surface of the sensing area.

According to another aspect of the invention, an exhaust gas sensor comprises: a sensing element having a sensing area detecting certain components in exhaust gas; a holder supporting a base end portion of the sensing element and having a sensor-mounting structure for sensor installation; and a protector fixed to the holder and protecting the sensing area of the sensing element, and both of a clearance between an inner surface of a sensing element insertion hole that is formed at the holder and a surface of the sensing area and a clearance between an inner surface of the protector and the surface of the sensing area are set to less than 0.9 mm.

The other objects and features of this invention will become understood from the following description with reference to the accompanying drawings.

### BRIEF DESCRIPTION OF THE DRAWINGS

FIG. 1 is a sectional view of a top end portion of an oxygen sensor according to the present invention.

FIG. 2 is a graph showing a relationship between diameter of condensed water (a clearance width) and rate of occurrence of an element crack.

### DETAILED DESCRIPTION OF THE INVENTION

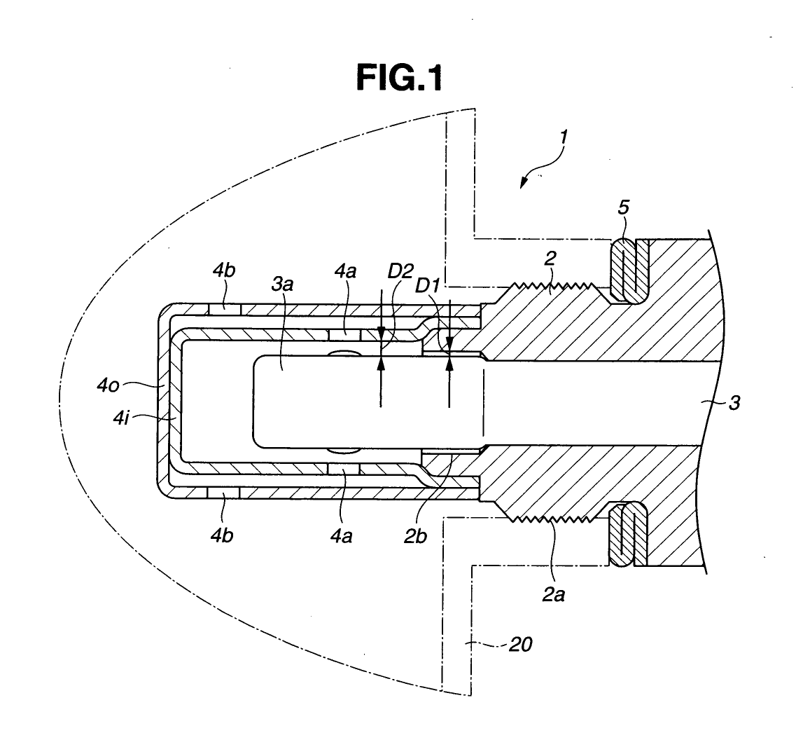

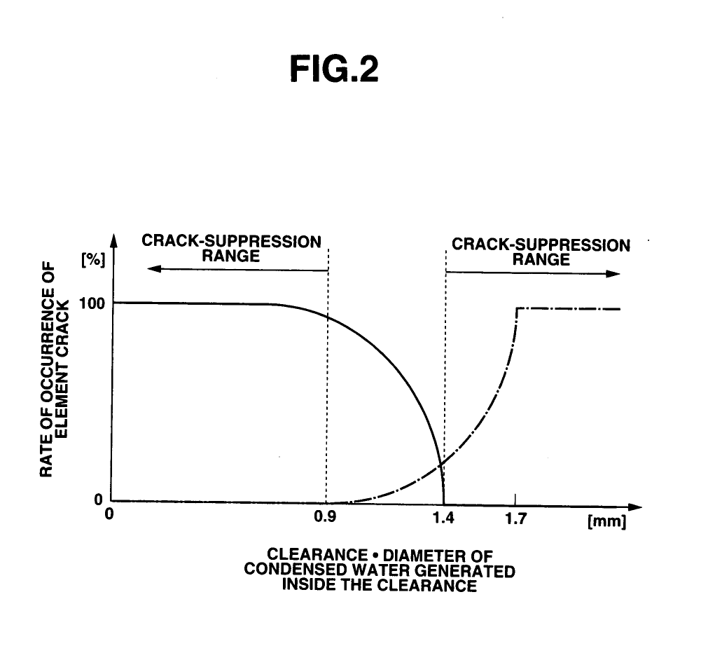

Embodiments of the present invention will be explained below with reference to the drawings. In the embodiment, a case is shown, where an oxygen sensor is used as an exhaust gas sensor, provided for an exhaust pipe of an internal combustion engine for air-fuel ratio detection. FIG. 1 is a sectional view (including a center axis of the oxygen sensor) of a top end portion of the oxygen sensor according to this embodiment. In the present invention, “top” side indicates left hand side of the oxygen sensor in FIG. 1, located at a side of the exhaust pipe. FIG. 2 is a graph showing a relationship between diameter of condensed water (a clearance width) and rate of occurrence of an element crack. Here, the condensed water is a water that is generated inside the clearance width (explained later) by condensation of water vapor, and its diameter size becomes nearly equal to the clearance width because of infinitesimal width of the clearance.

As shown in FIG. 1, a holder 2 formed of metallic materials (e.g. steel material) is positioned at an end side of the oxygen sensor 1. On an outer circumferential side of the holder 2, a threaded portion (sensor-mounting structure) 2a is formed for securing the sensor at a side of the exhaust pipe 20. Further, at a top end side of the holder 2, a tubular or cylindrical-shaped protector-fitting portion is formed. On the other hand, an insertion hole 2b is formed on an inner circumferential side of the holder 2. And a sensing rod (sensing element) 3 whose cross section is circular is inserted into the insertion hole 2b.

The sensing rod 3 penetrates the insertion hole 2b, and sticks out at both sides of FIG. 1 (a right hand side is not shown). At a left side hand, that is, at a side exposed to the exhaust gas, an oxygen-measuring portion (detecting or sensing portion or area) 3a is formed at one top end portion of the sensing rod 3. The oxygen-measuring portion 3a is formed by the sintering after an electrode layer, a solid electrolyte layer, and a protective layer that protects the above layers are printed there. In the sensing rod 3, a heater pattern etc. are also formed by the printing, and this allows a temperature of the oxygen-measuring portion 3a to rise promptly to an activation temperature by being energized.

In addition, a reading area of the electrode layer, a gas-diffusion layer that diffuses a reference gas (normally, the air), and a protective layer protecting the above layers are formed from the one top end portion (i.e. from the oxygen-measuring portion 3a at left hand side in FIG. 1) to the other top end portion (i.e. to the right hand side, not shown) of the sensing rod 3 by the sintering after the printing. This portion being a base end portion of the sensing rod 3 touches an inner surface of the insertion hole 2b of the holder 2, and then the sensing rod 3 is supported by the holder 2. On the other hand, as shown in FIG. 1, the oxygen-measuring portion 3a does not touch the inner surface of the substantially cylindrical-shaped insertion hole 2b opening at the top end side of the holder 2.

In order to protect the oxygen-measuring portion 3a, closed-bottomed cylindrical-shaped protectors 4i and 4o having a double pipe structure are fixed to the holder 2 by press-fitting or weld. Then, the oxygen-measuring portion 3a protruding from the holder 2 is covered with the protectors 4i and 4o. Or conversely, the oxygen-measuring portion 3a is inserted into the protectors 4i and 4o. In these inner protector 4i and outer protector 4o, gas flow holes (circular holes) 4a and 4b are respectively formed. A detection gas flows into or enters the inside of the protectors 4i and 4o through these gas flow holes 4a and 4b, and then reaches the oxygen-measuring portion 3a, or a space around the oxygen-measuring portion 3a is filled with the exhaust gas containing the detection gas. In FIG. 1, a member denoted by a reference number 5 is a seal member that seals a connecting portion (or installation portion) between the oxygen sensor 1 and the exhaust pipe 20.

More specifically about the gas flow holes 4a and 4b, as can be seen in FIG. 1, the gas flow holes 4a and 4b are arranged and open at different positions from each other in an axial direction of the sensor. This arrangement resists the entry of the condensed water generated outside the oxygen sensor 1 to the oxygen-measuring portion 3a located inside the inner protector 4i.

However, as explained above, the condensed water is generated also inside the inner protector 4i by the condensation of the water vapor. For this reason, in the embodiment, in order to suppress the crack of the oxygen-measuring portion 3a caused by contact with the water (water content), a clearance D1 between a surface of the oxygen-measuring portion 3a and the inner surface of the insertion hole 2b of the holder 2 is set to be smaller than a clearance D2 between the surface of the oxygen-measuring portion 3a and an inner surface of the inner protector 4i.

With this setting, the condensed water generated in a space between the surface of the oxygen-measuring portion 3a and the inner surface of the insertion hole 2b of the holder 2 easily escapes into a space between the surface of the oxygen-measuring portion 3a and the inner surface of the inner protector 4i. Conversely, the condensed water generated in the space between the surface of the oxygen-measuring portion 3a and the inner surface of the inner protector 4i becomes difficult to enter the space between the surface of the oxygen-measuring portion 3a and the inner surface of the insertion hole 2b of the holder 2. Hence, since the condensed water generated inside the oxygen sensor 1 becomes difficult to enter an inside of the oxygen sensor 1 and also becomes easy to escape to an outside of the oxygen sensor 1, it is possible to suppress the element crack resulting from the remaining condensed water generated inside the oxygen sensor 1.

Further, in the embodiment, with respect to the clearance D1 between the surface of the oxygen-measuring portion 3a and the inner surface of the insertion hole 2b of the holder 2 and the clearance D2 between the surface of the oxygen-measuring portion 3a and the inner surface of the inner protector 4i, both the clearances D1 and D2 are set to distances or widths other than a range that is greater than or equal to 0.9 mm and less than 1.4 mm. That is, the clearances D1 and D2 are set to a range that is less than 0.9 mm, or set to a range that is greater than or equal to 1.4 mm.

As previously described, the widths of the clearances D1 and D2 are infinitesimally small. Because of this, the diameter size of the condensed water becomes nearly equal to the clearance width of the D1 and D2. In the embodiment, the oxygen sensor 1 is attached to the exhaust pipe 20 such that the top end portion of the oxygen sensor 1 points down. Accordingly, when the clearances D1 and D2 are set to the range that is greater than or equal to 1.4 mm, the diameter size of the water condensing in the clearances D1 and D2 also becomes 1.4 mm or greater. In the case where the condensed water generated inside the sensor becomes the size as much as 1.4 mm or greater, this condensed water drops or drips down by its own weight. As a result, the condensed water does not remain at the oxygen-measuring portion 3a, and it can be possible to suppress the element crack. This is shown by a solid line on the graph obtained by experiments in FIG. 2. As seen in FIG. 2, in a case where the clearance is small, for instance, between 0 and 0.9 mm, the rate of occurrence of the element crack is almost 100%. However, when the clearance becomes greater, for instance, between 0.9 to 1.4 mm, the occurrence rate significantly decreases. Furthermore, when the clearance becomes 1.4 mm or greater, the occurrence rate becomes 0%. That is, as indicated by an arrow (right hand side arrow of two arrows), by setting the clearances D1 and D2 to 1.4 mm or greater, the diameter size of the water also becomes 1.4 mm or greater, and the condensed water drops. Then, the occurrence rate becomes 0%, namely that the element crack does not occur.

On the other hand, in the case where the clearances D1 and D2 are set to the range that is less than 0.9 mm, the diameter size of the water condensing in the clearances D1 and D2 also becomes less than 0.9 mm. Since this diameter size of the water is sufficiently small, the condensed water generated inside the sensor rapidly evaporates by heat of the exhaust gas. As a result, the condensed water does not remain at the oxygen-measuring portion 3a, and it can be possible to suppress the element crack. In FIG. 2, this is shown by a dashed line. That is, when the clearance, i.e. the diameter size of the water is large, for instance, larger than 1.7 mm, the rate of occurrence of the element crack is 100%. However, when the diameter size of the water becomes smaller, the occurrence rate exponentially decreases. Furthermore, when the diameter size of the water becomes less than 0.9 mm, as mentioned above, the condensed water rapidly evaporates by heat of the exhaust gas, and thus the occurrence rate of the crack becomes 0%. In FIG. 2, this non-crack range (crack-suppression range) is indicated by another arrow (left hand side arrow). Here, although the above two lines (the solid and the dashed lines) are drawn on the same graph in FIG. 2, these date are independently obtained by the respective experiments.

As explained above, by setting the clearances D1 and D2 to the range other than the range that is greater than or equal to 0.9 mm and also less than 1.4 mm, the crack of the oxygen-measuring portion 3a can be suppressed. Further, in the case where the clearances D1 and D2 are set to less than 0.9 mm, it is preferable that the clearances D1 and D2 be set to a range that is greater than or equal to 0.1 mm and less than 0.9 mm. That is, it is preferable to secure the clearance of 0.1 mm or greater. Because it is desirable that the oxygen-measuring portion 3a should not touch the inner surface of the insertion hole 2b of the holder 2 and the inner surface of the inner protector 4i. Moreover, in the case also where the clearances D1 and D2 are set to 1.4 mm or greater, it is preferable that the clearances D1 and D2 be set to a range that is greater than or equal to 1.4 mm and less than 7.0 mm. The clearance of 7.0 mm or greater leads to an undesirable large-size oxygen sensor. In addition, since the threaded portion 2a (connecting hole) where the oxygen sensor 1 is secured at the exhaust pipe 20 is formed to fit a standardized size of M18 of thread, in the case where the clearance is set to 7.0 mm or greater, a relatively great change of the sensor is required.

In the present invention, with respect to the clearance D2, it is preferable that the clearance D2 be applied to at least an area or space located from the gas flow hole 4a provided at the inner protector 4i (the closest gas flow hole to the top end of the holder 2) to a side of the holder 2 inside the inner protector 4i. The condensed water, generated from the water content in the exhaust gas, tends to remain at the side of the holder 2 more than the inner protector 4i. For this reason, by applying the clearance D2 to the above area, it is possible to effectively suppress the element crack which is apt to occur at the top end side of the holder 2.

Further, with respect to shape of the clearances D1 and D2, it is preferable that they be substantially ring-shaped and have constant-cross section. As mentioned above, since the condensed water, generated from the water content in the exhaust gas containing the detection gas, remains at the side of the holder 2, by specifying or defining the shape of the clearance located at the above area, it is possible to effectively suppress the element crack.

Furthermore, as shown in this embodiment, the sensing rod 3 is formed and provided such that its top end portion exposed to the exhaust gas is enlarged and the other portion (normal portion or base end side portion or non-enlarged portion) than the above enlarged portion is inserted into the insertion hole 2b. In such a configuration of the sensing rod 3, a border or boundary between the enlarged portion and non-enlarged portion is positioned in a tubular area that is a top end area of the insertion hole 2b, located at the top end side of the holder 2. In this case, on the non-enlarged portion around the border in the tubular area, the protective layer might not be formed, and therefore this non-enlarged portion might be thinner. As a result, a clearance between a surface of this thinner portion of the sensing rod 3 and an inner surface of the tubular area could be maximum. However, in this case as well, it is preferable that this maximum clearance be smaller than the clearance D2 (the minimum clearance at D2) between the inner surface of the inner protector 4i and the surface of the oxygen-measuring portion (the surface of the enlarged portion).

The exhaust gas sensor according to the present invention is not limited to the above mentioned embodiment. In the embodiment, the oxygen sensor is shown as the exhaust gas sensor. However, instead of the oxygen sensor, other exhaust gas sensors such as a NOx sensor, a linear air-fuel ratio sensor and a HC sensor, detecting the certain components in the exhaust gas, could be possible. Furthermore, the oxygen sensor has the rod-type sensing element in the embodiment. However, the oxygen sensor might have a cup-shaped or a plate type sensing element.

In the following, effects including the above mentioned effects will be explained.

(a) In the above exhaust gas sensor in the present invention, it is preferable to set the maximum clearance among clearances between the inner surface of the sensing element insertion hole formed at the holder and the surface of the sensing area to be smaller than the minimum clearance among clearances between the inner surface of the protector and the surface of the sensing area.

With this setting, even in a case where a sensing element whose cross section is rectangular (not circular) is inserted into the substantially cylindrical-shaped protector and sensing element insertion hole and then the clearance width is different depending on a position, a relationship of large and small among the clearances can be maintained. That is, the above setting can be applied to any exhaust gas sensors irrespective of the cross-section shapes of the sensing element, the protector and the sensing element insertion hole, and the condensed water generated inside the sensor can be prevented from remaining inside the sensor.

(b) In the above exhaust gas sensor in the present invention, in the case where both of the clearance between the inner surface of the sensing element insertion hole formed at the holder and the surface of the sensing area and the clearance between the inner surface of the protector and the surface of the sensing area are set to less than 0.9 mm, it is preferable to set these two clearances to 0.1 mm or greater.

With this setting, it is possible to prevent degradation of the detection performance caused by contact of the oxygen-measuring portion with the inner surface of the insertion hole or the inner surface of the protector, and also prevent occurrence of damage to the oxygen-measuring portion during assembly or installation.

(c) In the above exhaust gas sensor in the present invention, it is preferable that sensing element have the enlarged portion at the top end portion thereof and the border between this enlarged portion and the other portion than the enlarged portion be positioned inside the tubular area that is the top end area of the insertion hole, located at the top end side of the holder.

With this setting, in the exhaust gas sensor having the structure which is capable of suppressing problems such as damage to the enlarged portion formed at the top end portion of the sensing element due to the contact with the inner wall (surface) of the sensing element insertion hole by the provision of the tubular area, the condensed water generated inside the sensor can be certainly prevented from remaining inside the sensor.

Furthermore, in this case, it is preferable that the clearance (the maximum clearance at the non-enlarged portion) between the surface of the non-enlarged portion located at the side of the base end portion of the sensing element and the inner surface of the tubular area be smaller than the clearance (the minimum clearance at the enlarged portion) between the inner surface of the protector and the surface of the sensing area (the enlarged portion).

(d) In the above exhaust gas sensor in the present invention, it is preferable that each of the cross section of the clearance between the inner surface of the sensing element insertion hole formed at the holder and the surface of the sensing area and the cross section of the clearance between the inner surface of the protector and the surface of the sensing area be substantially constant along the axial direction of the sensor.

With this configuration, in addition to the above effects, it is possible to set or design the clearance easily, and also to facilitate control of the clearance during manufacturing. In particular, in the case where both the cross sections of these clearances are substantially ring-shaped cross sections, the above effects can effectively be obtained.

(e) In the above exhaust gas sensor in the present invention, in the case where the clearance between the inner surface of the sensing element insertion hole formed at the holder and the surface of the sensing area is set to be smaller than the clearance between the inner surface of the protector and the surface of the sensing area, it is preferable to set these two clearances to less than 0.9 mm.

With this setting, the condensed water becomes difficult to enter the inside of the sensor and also is easily discharged or escapes to the outside of the sensor. Moreover, the condensed water easily evaporates, and the condensed water can be further prevented from remaining inside the sensor.

This application is based on a prior Japanese Patent Application No. 2006-074651 filed on Mar. 17, 2006, and a prior Japanese Patent Application No. 2007-009032 filed on Jan. 18, 2007. The entire contents of these Japanese Patent Applications Nos. 2006-074651 and 2007-009032 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. An exhaust gas sensor comprising:
a sensing element having a sensing area detecting certain components in exhaust gas;
a holder supporting a base end portion of the sensing element and having a sensor-mounting structure for sensor installation; and
a protector fixed to the holder and protecting the sensing area of the sensing element, and
a clearance between an inner surface of a sensing element insertion hole that is formed at the holder and a surface of the sensing area being set to be smaller than a clearance between an inner surface of the protector and the surface of the sensing area.

2. The exhaust gas sensor as claimed in claim 1, wherein:
a gas flow hole is formed at the protector,
and wherein:
the clearance between the inner surface of the sensing element insertion hole and the surface of the sensing area is applied to a clearance located inside a tubular area that is a top end area of the sensing element insertion hole, located at a top end side of the holder, and
the clearance between the inner surface of the protector and the surface of the sensing area is applied to a clearance located between the closest gas flow hole to the top end portion of the holder and the top end portion of the holder in the protector.

3. The exhaust gas sensor as claimed in claim 2, wherein:
an enlarged portion is formed at a top end side of the sensing element,
and wherein:
a border between the enlarged portion and a non-enlarged portion other than the enlarged portion of the sensing element is positioned inside the tubular area.

4. The exhaust gas sensor as claimed in claim 3, wherein:
a clearance between a surface of the non-enlarged portion of the sensing element, which is located from the border to the base end portion of sensing element in the tubular area, and an inner surface of the tubular area is smaller than the clearance between the inner surface of the protector and the surface of the sensing area.

5. The exhaust gas sensor as claimed in claim 1, wherein:
a maximum clearance among clearances between the inner surface of the sensing element insertion hole formed at the holder and the surface of the sensing area is set to be smaller than a minimum clearance among clearances between the inner surface of the protector and the surface of the sensing area.

6. The exhaust gas sensor as claimed in claim 1, wherein:
a cross section of the clearance between the inner surface of the sensing element insertion hole formed at the holder and the surface of the sensing area and a cross section of the clearance between the inner surface of the protector and the surface of the sensing area are each formed to be substantially constant along an axial direction of the sensor.

7. The exhaust gas sensor as claimed in claim 1, wherein:
the clearance between the inner surface of the sensing element insertion hole formed at the holder and the surface of the sensing area is set to less than 0.9 mm.

8. The exhaust gas sensor as claimed in claim 7, wherein:
the clearance between the inner surface of the protector and the surface of the sensing area is set to be greater than or equal to 1.4 mm.

9. An exhaust gas sensor comprising:
a sensing element having a sensing area detecting certain components in exhaust gas;
a holder supporting a base end portion of the sensing element and having a sensor-mounting structure for sensor installation; and
a protector fixed to the holder and protecting the sensing area of the sensing element, and
both of a clearance between an inner surface of a sensing element insertion hole that is formed at the holder and a surface of the sensing area and a clearance between an inner surface of the protector and the surface of the sensing area being set to less than 0.9 mm.

10. The exhaust gas sensor as claimed in claim 9, wherein:
a gas flow hole is formed at the protector,
and wherein:
the clearance between the inner surface of the sensing element insertion hole and the surface of the sensing area is applied to a clearance located inside a tubular area that is a top end area of the sensing element insertion hole, located at a top end side of the holder, and
the clearance between the inner surface of the protector and the surface of the sensing area is applied to a clearance located between the closest gas flow hole to the top end portion of the holder and the top end portion of the holder in the protector.

11. The exhaust gas sensor as claimed in claim 10, wherein:
an enlarged portion is formed at a top end side of the sensing element,
and wherein:
a border between the enlarged portion and a non-enlarged portion other than the enlarged portion of the sensing element is positioned inside the tubular area.

12. The exhaust gas sensor as claimed in claim 11, wherein:
a clearance between a surface of the non-enlarged portion of the sensing element, which is located from the border to the base end portion of sensing element in the tubular area, and an inner surface of the tubular area is smaller than the clearance between the inner surface of the protector and the surface of the sensing area.

13. The exhaust gas sensor as claimed in claim 9, wherein:
both of the clearance between the inner surface of the sensing element insertion hole formed at the holder and the surface of the sensing area and the clearance between the inner surface of the protector and the surface of the sensing area are set to be greater than or equal to 0.1 mm.

14. The exhaust gas sensor as claimed in claim 9, wherein:
a cross section of the clearance between the inner surface of the sensing element insertion hole formed at the holder and the surface of the sensing area and a cross section of the clearance between the inner surface of the protector and the surface of the sensing area are each formed to be substantially constant along an axial direction of the sensor.
